(19) United States
(12) Patent Application Publication
(10) Pub. No.: US 2019/0380893 A1
(43) Pub. Date: Dec. 19, 2019

(54) DRIVING METHOD OF WHEELCHAIR POWER APPARATUS FOR ELECTRONIC DRIVING CONVERSION

(71) Applicants: Joon-Hyung KIM, Seoul (KR); Tae-Ho KANG, Seoul (KR); Seong Hyun PAEK, Gwangju-si (KR)

(72) Inventors: Joon-Hyung KIM, Seoul (KR); Tae-Ho KANG, Seoul (KR); Seong Hyun PAEK, Gwangju-si (KR)

(21) Appl. No.: 16/149,016

(22) Filed: Oct. 1, 2018

(30) Foreign Application Priority Data
Jun. 14, 2018 (KR) 10-2018-0068215

(51) Int. Cl. A61G 5/04; A61G 5/10

(52) U.S. Cl. CPC A61G 5/047; A61G 5/1051; A61G 5/042

(57) ABSTRACT

Disclosed is a driving method of a wheelchair power apparatus for electronic driving conversion. It is an object of the present invention to provide a wheelchair power apparatus for electronic driving conversion, which can provide severely disabled people, for instance, patients with spinal cord injury, the weak or the old, who use wheelchairs, with convenience in movement, and convert a manual four-wheel wheelchair into an electronic three-wheel wheelchair just by detachably mounting the electronic module having electronic wheels to the existing manual four-wheel wheelchair.

### BACKGROUND OF THE INVENTION

### Field of the Invention

The present invention relates to a driving method of a wheelchair power apparatus for electronic driving conversion, and more particularly, to a driving method of a wheelchair power apparatus for electronic driving conversion, which can convert a manual wheelchair of a four-wheel type into an electronic wheelchair of a three-wheel type since having an electronic module detachably mounted on the manual wheelchair, which drives when a disabled person, an old person or a weak person rolls wheels with hands.

### Background Art

A driving method of a power apparatus according to the present invention will be described in brief as follows. When a rider rotates a grip of an operation handle in a state that the rider holds the operation handle with his or her fingers, the power apparatus drives forwards. When the rider adjusts rotational speed of the grip rapidly, driving speed gets faster due to acceleration. Moreover, in order to decrease speed during driving or stop the wheelchair, when the rider pulls a brake handle mounted on the operation handle, brake force is generated to the power apparatus.

The above-mentioned driving method of a power apparatus is very simple and general, so even the disabled who ride on wheelchairs can operate and manipulate wheelchairs without any difficulty.

However, in case of the disabled who have spiral cord injuries due to traffic accidents, crash, or various diseases, motor nerve and sensory nerves gradually slow down due to abnormality of central nerves, and in consequence, the peripheral nerves are not operated delicately.

Therefore, in case of spinal cord injury patients who ride electronic wheelchairs, since it is impossible to operate the grip mounted on the operation handle using his or her fingers or to do delicate operations, for instance, to operate a brake handle, the conventional driving method of the electronic wheelchair has a problem in operating the electronic wheelchair.

### SUMMARY OF THE INVENTION

Accordingly, the present invention has been made to solve the above-mentioned problems occurring in the prior arts, and it is an object of the present invention to provide a wheelchair power apparatus for electronic driving conversion, which can provide severely disabled people, for instance, patients with spinal cord injury, the weak or the old, who use wheelchairs, with convenience in movement, and convert a manual four-wheel wheelchair into an electronic three-wheel wheelchair just by detachably mounting the electronic module having electronic wheels to the existing manual four-wheel wheelchair.

To accomplish the above object, according to the present invention, there is provided a driving method of a wheelchair power apparatus for electronic driving conversion including the steps of: (S110) preparing driving by supplying electric power; (S120) driving a wheelchair forwards while a steering unit mounted at an end of an operation handle rotates at a predetermined angle when a rider pulls the operation handle toward his or her chest, wherein a driving speed increases as a rotation angle of the steering unit increases gradually; (S130) when the rider removes the power to pull the operation handle during forward driving, returning the operation handle to its original position by restoring power of the coil spring mounted on the steering unit, and stopping the wheelchair while the operation handle is returned to its original position; (S140) changing the driving direction from a forward mode to a backward mode or from a backward mode to a forward mode when the rider pushes the operation handle forwards once in the state that the operation handle is returned to its original position during driving; and (S150) when the rider pulls the operation handle toward his or her chest in the state that the driving direction is changed into the backward mode, driving the wheelchair backwards while the steering unit mounted at the end of the operation handle rotates at a predetermined angle, wherein the driving speed increases as the rotation angle of the steering unit increases gradually.

According to the present invention, the driving method of the wheelchair power apparatus for electronic driving conversion is created for severely disabled people, for instance, patients with spinal cord injury, and people who have a difficulty in delicate driving using the fingers. The driving method of the wheelchair power apparatus for electronic driving conversion can control the driving direction and the driving speed just when the rider pushes or pulls the operation handle 31 forwards or backwards in a state that the rider simply puts the palm or the wrist on the operation handle 31.

Moreover, the driving method of the wheelchair power apparatus for electronic driving conversion can provide the disabled, the weak or the old with convenience by simply converting the existing manual four-wheel wheelchair into the electronic three-wheel wheelchair.

In the meantime, the present invention can reduce burden of expenses because there is no need to buy a high-priced electronic wheelchair, and can provide convenience in movement at a place to visit or at a vacation spot since a general electronic wheelchair cannot be loaded in a trunk of a vehicle but the wheelchair according to the present invention can be loaded in a trunk of a vehicle after the electronic module 30 is separated from the manual wheelchair and the wheelchair is folded.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view of a general wheelchair;

FIG. 2 is a perspective view of a wheelchair on which an electronic module according to the present invention is mounted;

FIG. 3 is an exploded perspective view of the electronic module according to the present invention;

FIG. 4 is an exploded perspective view for explaining a steering housing and a steering unit according to the present invention;

FIG. 5 is a side view for explaining operation of the electronic module of the present invention;

FIG. 6 is a first flow chart showing a driving method of a wheelchair power apparatus for electronic driving conversion;

FIG. 7 is a second flow chart showing a driving method of a wheelchair power apparatus for electronic driving conversion;

FIG. 8 is a third flow chart showing a driving method of a wheelchair power apparatus for electronic driving conversion; and

FIG. 9 is a fourth flow chart showing a driving method of a wheelchair power apparatus for electronic driving conversion.

### DETAILED DESCRIPTION OF THE PREFERRED EMBODIMENT

Hereinafter, reference will be now made in detail to the preferred embodiment of the present invention with reference to the attached drawings. In the description of the present invention, when it is judged that detailed descriptions of known functions or structures and systems related with the present invention may make the essential points vague, the detailed descriptions of the known functions or structures will be omitted.

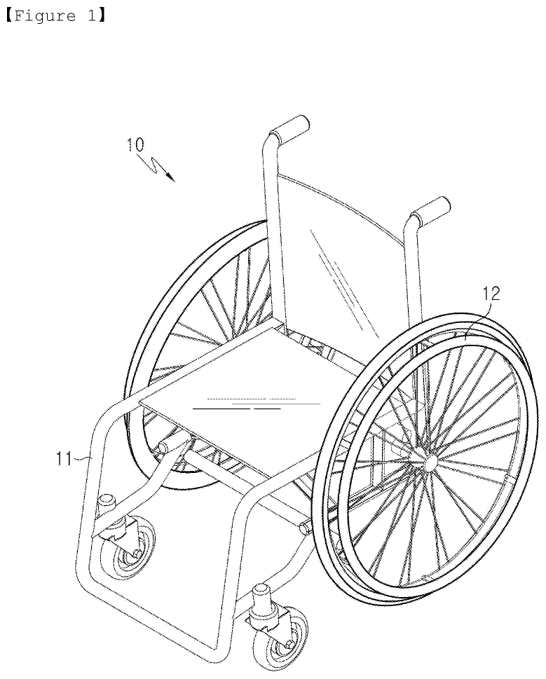

FIG. 1 is a perspective view of a general wheelchair. The wheelchair 10 illustrated in FIG. 1 is a manual wheelchair 10, which is used as a transportation means for the disabled or the old. The wheelchair includes large wheels mounted at both sides of a seat for driving and small wheels mounted sides of foot rests to be able to rotate a full 360 degrees for direction change, so is operated in a four-wheel drive type.

The manual wheelchair 10 illustrated in FIG. 1 can be loaded on a vehicle for a long distance movement since being lightweight and being capable of narrowing the width between the wheels based on the seat to reduce volume. However, considering that a rider who is disabled holds an actuation rim 12 mounted along the edge of the wheel and operates the wheel just with muscle strength sitting on the seat, the manual wheelchair 10 is limited as an assistant transportation means for short-distance driving.

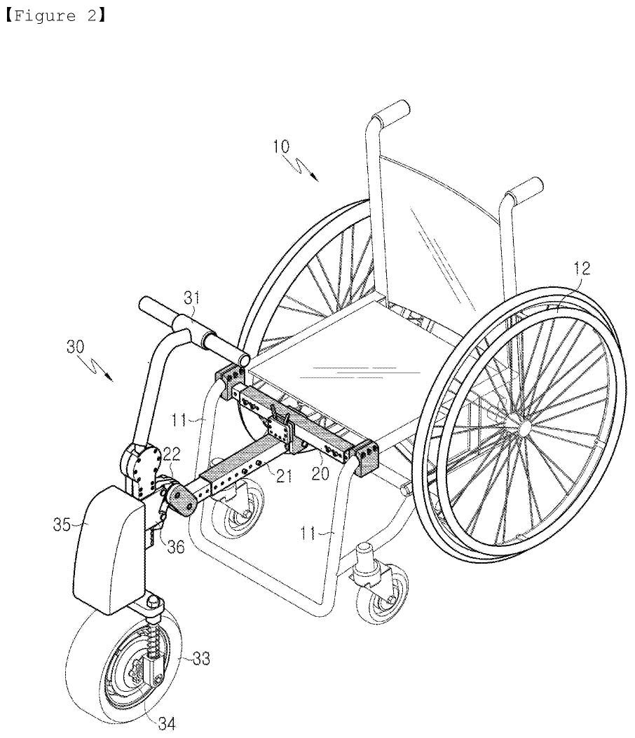

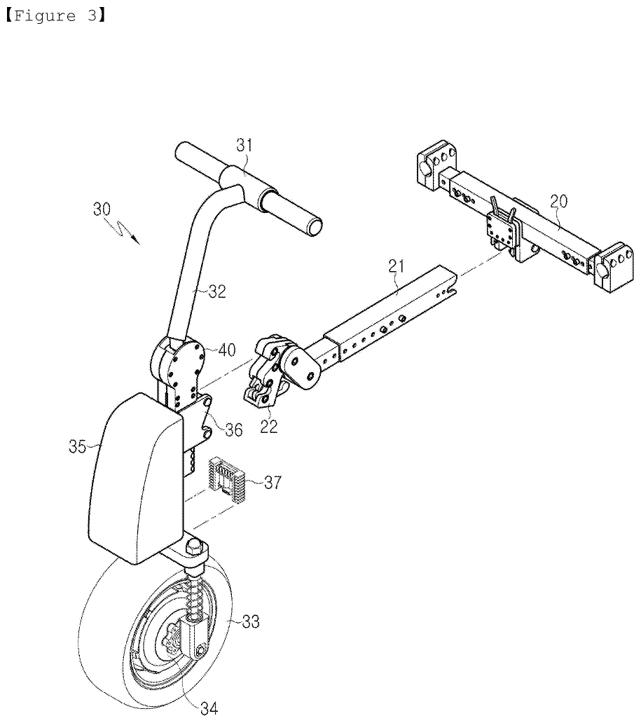

FIG. 2 is a perspective view of a wheelchair 10 on which an electronic module 30 according to the present invention is mounted, and FIG. 3 is an exploded perspective view of the electronic module 30 according to the present invention. As shown in FIGS. 2 and 3, the electronic module 30 is located at the front of the manual wheelchair 10. The electronic module 30 is connected with a seat frame 11 of the wheelchair 10, and is detachably and conveniently combined in a one-touch way through components, such as a horizontal clamp 20, a vertical clamp 21, a combining unit 22, and so on.

The electronic module 30 includes: an operation wheel 33 in which an in-wheel motor 34 is mounted; a detachable battery 35 for supplying electric power; an operation handle 31 mounted directly above the battery 35 for allowing the rider to grip with the fingers or to put the palm or the wrist; and a connector 32 connected to the operation handle 31 so that the connector 32 can move in a forward or backward direction inside a steering housing 40.

Moreover, a fastener 36 is mounted directly below the steering housing 40. The fastener 36 is combined with the combining unit 22 in a one-touch way so that the electronic module 30 is easily mounted on the wheelchair 10.

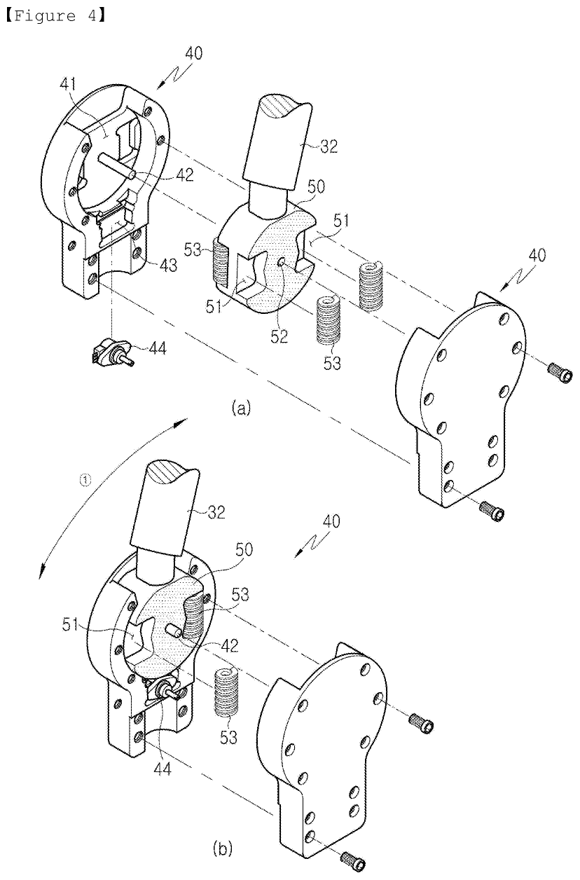

FIG. 4 is an exploded perspective view for explaining the steering housing 40 and a steering unit 50 according to the present invention. As shown in FIG. 4(A), the steering housing 40 is made in a split type for easy assembly and can be integrated through a bolt.

A first mounting recess 41 in which the steering unit 50 is located is formed at the central portion inside the steering housing 40, and a rotary shaft 42 protrudes at the center of the first mounting recess 41 and fit into a fitting hole 52 formed at the center of the steering unit 50 so as to be rotated smoothly within a predetermined angle in forward and backward directions in a state that the steering unit 50 is mounted inside the steering housing 40.

Elastic body seating recesses 51 are formed at right and left sides of the steering unit 50 to be symmetrical to the front and the back based on the fitting hole 52. The elastic body seating recess 51 is a space where an elastic body, such as a coil spring 53, is mounted. In the present invention, the elastic body is a coil spring 53, but shapes and kinds of the elastic body is not limited.

The connector 32 of the operation handle 31 is mounted on the steering unit 50. When the rider moves the operation handle 31 forwards or backwards, as illustrated by the reciprocating arrow \textcircled{1} in FIG. 4(B), the steering unit 50 moves forwards or backwards at a predetermined angle inside the steering housing 40 as the rider set the steering direction.

As described above, the driving direction and speed of the electronic module 30 are maintained depending on movement of the steering unit 50 operated by the rider's power. When the power of the rider who pushes or pulls the steering unit 50 is removed, the steering unit 50 is restored into an initial state, namely, into a neutral condition by restoring force of the coil spring 53, and the electronic module 30 is in a braking state.

In the meantime, as shown in FIG. 4(A), a second mounting recess 43 in which an encoder 44 is mounted is formed directly below the first mounting recess 41 of the steering housing 40. The encoder 44 is located directly below the steering unit 50 as shown in FIG. 4(B) after being assembled. Therefore, when the steering unit 50 is rotated forwards or backwards, because the encoder 44 which controls the number of turns of the operation wheel 33 is operated, a driving speed is reduced if an angle of rotation of the steering unit 50 is small, and the wheelchair is stopped when the steering unit 50 is in a neutral condition that the angle of rotation is zero.

Furthermore, as shown in FIG. 3, a controller 37 is mounted at a portion of the electronic module 30. The controller 37 controls operation of the encoder 44 and various electrical processes related with driving directions, driving speed, and braking of the electronic module 30.

Detailed technical contents related with operations of the encoder 44 and the controller 37 have been well known, so the detailed description of the encoder and the controller will be omitted.

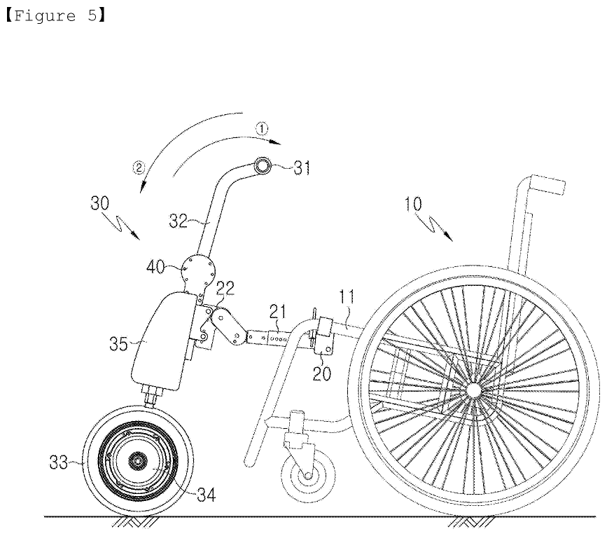

FIG. 5 is a side view for explaining operation of the electronic module 30 of the present invention. As shown in FIG. 5, when the electronic module 30 is mounted on the manual wheelchair 10, the 360-degree rotatable small wheels assembled to the wheelchair 10 is lifted from the ground and is conveniently converted from the manual four-wheel type wheelchair 10 into the electronic three-wheel type wheelchair 10 to provide the disabled or the weak with convenience in movement.

Meanwhile, considering that the wheelchair having the electronic module is a detachable type, for long-distance movement, the manual wheelchair 10 is folded and loaded on a vehicle and the electronic module 30 and other coupling means are separated from the wheelchair and loaded on the vehicle. At a destination, the manual four-wheel wheelchair 10 is converted into the electronic three-wheel wheelchair 10, so the wheelchair according to the present invention provides vulnerable users with convenience in movement and enriches their lives.

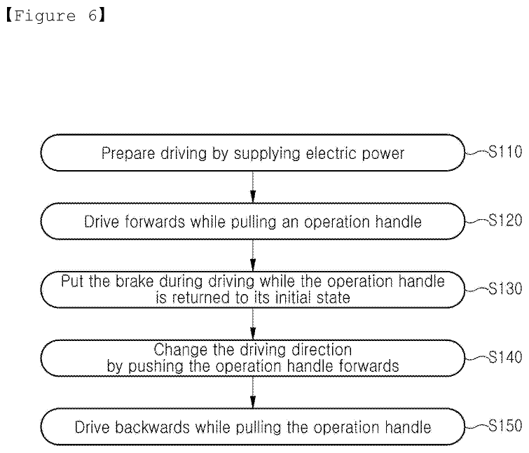

Hereinafter, referring to FIGS. 6 to 9, a driving method of a wheelchair power apparatus for electronic driving conversion will be described in detail as follows.

FIG. 6 is a first flow chart showing a driving method of a wheelchair power apparatus for electronic driving conversion. In the first driving method, in a state that the operation handle 31 maintains its original position by restoring force of the coil spring 53 mounted on the steering unit 50 inside the steering housing 40, the rider supplies electric power to prepare driving (Step of preparing driving by supplying electric power (S110)). An initial power supply state is a forward driving mode state.

As described above, when electric power is supplied, as indicated by the arrow number \textcircled{1} in FIG. 5, the rider pulls the operation handle 31 toward his or her chest. In this instance, the steering unit 50 mounted at the end of the operation handle 31 operates the encoder 44 while rotating at a predetermined angle, and the wheelchair 10 drives forwards while the operation wheel 33 is rotated according to operation of the encoder 44. As the rotation angle increases, the driving speed increases (Step of driving forwards while pulling the operation handle (S120)).

When the rider removes the power to pull the operation handle 31 toward the chest during forward driving, restoring power is generated from the coil spring 53 mounted on the steering unit 50 inside the steering housing 40, and the operation handle 31 is naturally restored in place. The wheelchair 10 stops as the encoder 44 returns to its initial state (Step of putting the brake during driving while the operation handle is returned to its initial state (S130)).

In the state that the operation handle 31 is in the initial state during driving, as indicated by the arrow number a in FIG. 5, the rider pushes the operation handle 31 forwards once. In this instance, the driving direction is changed from a forward mode to a backward mode (Step of changing the driving direction by pushing the operation handle forwards (S140)).

For your reference, if the driving direction before the operation handle 31 returns to its original state is a backward mode, when the operation handle 31 is pushed forwards once, the backward mode is changed into the forward mode.

In the state that the driving direction is in the backward mode, as indicated by the arrow number \textcircled{2} in FIG. 5, the rider pulls the operation handle 31 toward the rider's chest. In this instance, the steering unit 50 mounted at the end of the operation handle 31 rotates at a predetermined angle to operate the encoder 44, and the wheelchair 10 drives backwards while the operation wheel 33 rotates by operation of the encoder 44. As the rotation angle increases, the driving speed increases (Step of driving backwards when the operation handle is pulled (S150)).

In the step of driving backwards, it is preferable to add sound effects in order to provide safety in driving in the rear of bad visibility.

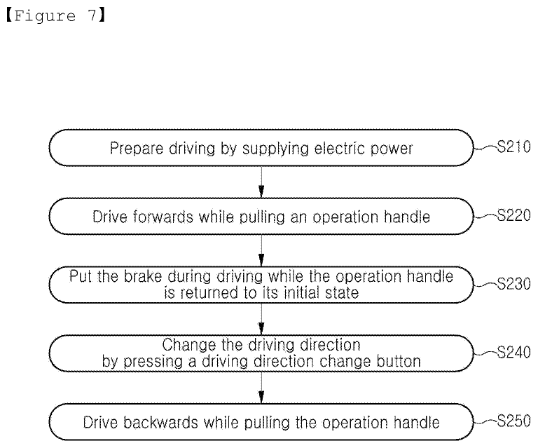

FIG. 7 is a second flow chart showing a driving method of a wheelchair power apparatus for electronic driving conversion. In the second driving method, the rider supplies electric power to prepare driving in a state that the operation handle 31 maintains its original position due to restoring force of the coil spring 53 mounted on the steering unit 50 inside the steering housing 40 (Step of preparing driving by supplying electric power (S210)). An initial state of power supply means a forward driving mode state.

As described above, when electric power is applied, as indicated by the arrow number \textcircled{1} in FIG. 5, the rider pulls the operation handle 31 toward his or her chest. In this instance, the steering unit 50 mounted at the end of the operation handle 31 operates the encoder 44 while rotating at a predetermined angle, the operation wheel 33 rotates according to operation of the encoder 44, and the driving speed increases as the rotation angle increases (Step of driving forwards while pulling the operation handle (S220)).

When the rider removes the pulling power from the operation handle 31 while driving forwards, the operation handle 31 is naturally restored to its original position while restoring power is generated from the coil spring 53 mounted on the steering unit 50 inside the steering housing 40. In the above process, the encoder 44 returns to its initial state, and the wheelchair 10 stops (Step of braking while returning the operation handle to its original position (S230)).

In the state that the operation handle 31 is in the original position, when the rider presses a driving direction change button mounted on the operation handle 31, the driving direction is changed from the forward mode to the backward mode (Step of changing a driving direction by pressing the driving direction change button (S240)). The driving direction change button is mounted to change the driving mode, and the controller changes the driving direction according to a signal of the change button.

For your reference, if the backward mode is the backward mode before the operation handle 31 is in the original position, when the rider presses the change button, the driving direction is changed from the backward mode to the forward mode.

In the state that the driving direction has been changed into the backward mode, as indicated by the arrow number \textcircled{1} in FIG. 5, the rider pulls the operation handle 31 toward the rider's chest. In this instance, the steering unit 50 mounted at the end of the operation handle 31 operates the encoder 44 while rotating at the predetermined angle, the wheelchair 10 drives backwards while the operation wheel 33 rotates according to the operation of the encoder 44, and the driving speed gets increased as the rotation angle increases (Step of driving backwards while pulling the operation handle (S250)).

In the step of driving backwards, it is preferable to add sound effects in order to provide safety in driving in the rear of bad visibility.

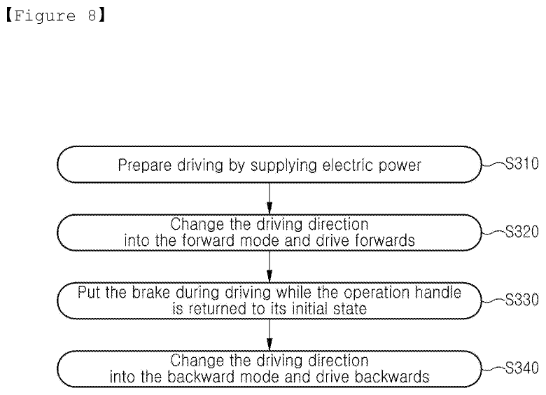

FIG. 8 is a third flow chart showing a driving method of a wheelchair power apparatus for electronic driving conversion. In the first driving method, in a state that the operation handle 31 maintains its original position by restoring force of the coil spring 53 mounted on the steering unit 50 inside the steering housing 40, the rider supplies electric power to prepare driving (Step of preparing driving by supplying electric power (S310)).

As described above, when electric power is supplied, as indicated by the arrow number \textcircled{1} in FIG. 5, the rider pulls the operation handle 31 toward his or her chest. In this instance, the driving mode is changed into the forward mode, and at the same time, the steering unit 50 mounted at the end of the operation handle 31 operates the encoder 44 while rotating at a predetermined angle, and the wheelchair 10 drives forwards while the operation wheel 33 is rotated according to operation of the encoder 44. As the rotation angle increases, the driving speed increases (Step of changing the driving direction into the forward mode and step of driving forwards (S320)).

When the rider removes the power to pull the operation handle 31 toward the chest during forward driving, restoring power is generated from the coil spring 53 mounted on the steering unit 50 inside the steering housing 40, and the operation handle 31 is naturally restored in place. The wheelchair 10 stops as the encoder 44 returns to its initial state (Step of putting the brake during driving while the operation handle is returned to its initial state (S330)).

In the state that the operation handle 31 is in the initial state during driving, as indicated by the arrow number \textcircled{2} in FIG. 5, the rider pushes the operation handle 31 forwards. In this instance, the driving direction is changed into the forward mode, and at the same time, the steering unit 50 mounted at the end of the operation handle 31 operates the encoder 44 while rotating at a predetermined angle, and the wheelchair 10 drives backwards while the operation wheel 33 is rotated according to operation of the encoder 44. As the rotation angle increases, the driving speed increases (Step of changing the driving direction into the backward mode and step of driving backwards (S340)).

In the step of driving backwards, it is preferable to add sound effects in order to provide safety in driving in the rear of bad visibility.

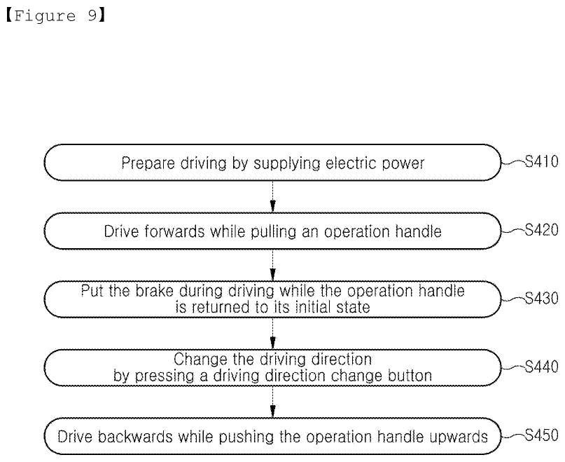

FIG. 9 is a fourth flow chart showing a driving method of a wheelchair power apparatus for electronic driving conversion. In the fourth driving method, in a state that the operation handle 31 maintains its original position by restoring force of the coil spring 53 mounted on the steering unit 50 inside the steering housing 40, the rider supplies electric power to prepare driving (Step of preparing driving by supplying electric power (S410)). An initial power supply state is a forward driving mode state.

As described above, when electric power is supplied, as indicated by the arrow number \textcircled{1} in FIG. 5, the rider pulls the operation handle 31 toward his or her chest. In this instance, the steering unit 50 mounted at the end of the operation handle 31 operates the encoder 44 while rotating at a predetermined angle, and the wheelchair 10 drives forwards while the operation wheel 33 is rotated according to operation of the encoder 44. As the rotation angle increases, the driving speed increases (Step of driving forwards while pulling the operation handle (S420)).

When the rider removes the power to pull the operation handle 31 toward the chest during forward driving, restoring power is generated from the coil spring 53 mounted on the steering unit 50 inside the steering housing 40, and the operation handle 31 is naturally restored in place. The wheelchair 10 stops as the encoder 44 returns to its initial state (Step of putting the brake during driving while the operation handle is returned to its initial state (S430)).

In the state that the operation handle 31 is in the original position, when the rider presses a driving direction change button mounted on the operation handle 31, the driving direction is changed from the forward mode to the backward mode (Step of changing a driving direction by pressing the driving direction change button (S440)). The driving direction change button is mounted to change the driving mode, and the controller changes the driving direction according to a signal of the change button.

For your reference, if the backward mode is the backward mode before the operation handle 31 is in the original position, when the rider presses the change button, the driving direction is changed from the backward mode to the forward mode.

In the state that the driving direction has been changed into the backward mode, as indicated by the arrow number \textcircled{2} a in FIG. 5, the rider pushes the operation handle 31 forwards. In this instance, the steering unit 50 mounted at the end of the operation handle 31 operates the encoder 44 while rotating at a predetermined angle, and the wheelchair 10 drives backwards while the operation wheel 33 is rotated according to operation of the encoder 44. As the rotation angle increases, the driving speed increases (Step of driving backwards while pushing up the operation handle (S450)).

In the step of driving backwards, it is preferable to add sound effects in order to provide safety in driving in the rear of bad visibility.

As described above, the driving method of the wheelchair power apparatus for electronic driving conversion has been created for severely disabled people, for instance, patients with spinal cord injury, and people who have a difficulty in delicate driving using the fingers. The present invention can control the driving direction and the driving speed just when the rider pushes or pulls the operation handle 31 forwards or backwards in a state that the rider simply puts the palm or the wrist on the operation handle 31.

Moreover, the present invention can provide the disabled, the weak or the old with convenience by simply converting the existing manual four-wheel wheelchair into the electronic three-wheel wheelchair.

In the meantime, the present invention can reduce burden of expenses because there is no need to buy a high-priced electronic wheelchair, and can provide convenience in movement at a place to visit or at a vacation spot since a general electronic wheelchair cannot be loaded in a trunk of a vehicle but the wheelchair according to the present invention can be loaded in a trunk of a vehicle after the electronic module 30 is separated from the manual wheelchair and the wheelchair is folded.

What is claimed is:

1. A driving method of a wheelchair power apparatus for electronic driving conversion comprising the steps of:
(S110) preparing driving by supplying electric power;
(S120) driving a wheelchair forwards while a steering unit mounted at an end of an operation handle rotates at a predetermined angle when a rider pulls the operation handle toward his or her chest, wherein a driving speed increases as a rotation angle of the steering unit increases gradually;
(S130) when the rider removes the power to pull the operation handle during forward driving, returning the operation handle to its original position by restoring power of the coil spring mounted on the steering unit, and stopping the wheelchair while the operation handle is returned to its original position;
(S140) changing the driving direction from a forward mode to a backward mode or from a backward mode to a forward mode when the rider pushes the operation handle forwards once in the state that the operation handle is returned to its original position during driving; and
(S150) when the rider pulls the operation handle toward his or her chest in the state that the driving direction is changed into the backward mode, driving the wheelchair backwards while the steering unit mounted at the end of the operation handle rotates at a predetermined angle, wherein the driving speed increases as the rotation angle of the steering unit increases gradually.

2. A driving method of a wheelchair power apparatus for electronic driving conversion comprising the steps of:
(S210) preparing driving by supplying electric power;
(S220) driving a wheelchair forwards while a steering unit mounted at an end of an operation handle rotates at a predetermined angle when a rider pulls the operation handle toward his or her chest, wherein a driving speed increases as a rotation angle of the steering unit increases gradually;
(S230) when the rider removes the power to pull the operation handle during forward driving, returning the operation handle to its original position by restoring power of the coil spring mounted on the steering unit, and stopping the wheelchair while the operation handle is returned to its original position;
(S240) changing the driving direction from a forward mode to a backward mode or from a backward mode to a forward mode when the rider presses a driving direction change button in the state that the operation handle is returned to its original position during driving; and
(S250) when the rider pulls the operation handle toward his or her chest in the state that the driving direction is changed into the backward mode, driving the wheelchair backwards while the steering unit mounted at the end of the operation handle rotates at a predetermined angle, wherein the driving speed increases as the rotation angle of the steering unit increases gradually.

3. A driving method of a wheelchair power apparatus for electronic driving conversion comprising the steps of:
(S310) preparing driving by supplying electric power;
(S320) changing a driving mode into a forward mode, and at the same time, driving a wheelchair forwards while a steering unit mounted at an end of an operation handle rotates at a predetermined angle when a rider pulls the operation handle toward his or her chest, wherein a driving speed increases as a rotation angle of the steering unit increases gradually;
(S330) when the rider removes the power to pull the operation handle during forward driving, returning the operation handle to its original position by restoring power of the coil spring mounted on the steering unit, and stopping the wheelchair while the operation handle is returned to its original position;
(S340) in the state that the operation handle is returned to its original position during driving, when the rider pulls the operation handle forwards, changing the driving mode into the backward mode, and driving the wheelchair backwards while the steering unit mounted at the end of the operation handle rotates at a predetermined angle, wherein the driving speed increases as the rotation angle of the steering unit increases gradually.

4. A driving method of a wheelchair power apparatus for electronic driving conversion comprising the steps of:
(S410) preparing driving by supplying electric power;
(S420) driving a wheelchair forwards while a steering unit mounted at an end of an operation handle rotates at a predetermined angle when a rider pulls the operation handle toward his or her chest, wherein a driving speed increases as a rotation angle of the steering unit increases gradually;
(S430) when the rider removes the power to pull the operation handle during forward driving, returning the operation handle to its original position by restoring power of the coil spring mounted on the steering unit, and stopping the wheelchair while the operation handle is returned to its original position;
(S440) changing the driving direction from a forward mode to a backward mode or from a backward mode to a forward mode when the rider presses a driving direction change button in the state that the operation handle is returned to its original position during driving; and
(S450) when the rider pushes the operation handle toward his or her chest in the state that the driving direction is changed into the backward mode, driving the wheelchair backwards while the steering unit mounted at the end of the operation handle rotates at a predetermined angle, wherein the driving speed increases as the rotation angle of the steering unit increases gradually.
